(19) United States
(12) Patent Application Publication
(10) Pub. No.: US 2005/0086107 A1
(43) Pub. Date: Apr. 21, 2005

(54) Advertisement for leather clothing

(75) Inventor: G. Clotaire Rapaille, (US)

Correspondence Address: MARSHALL, GERSTEIN & BORUN LLP, 6300 SEARS TOWER, 233 S. WACKER DRIVE, CHICAGO, IL, 60606, US

(73) Assignee: Danier Leather, Inc.

(21) Appl. No.: 10/909,694

(22) Filed: Aug. 2, 2004

Related U.S. Application Data
(60) Provisional application No. 60/491,229, filed on Jul. 31, 2003.

(51) Int. Cl. G06F 17/60

(52) U.S. Cl. 705/14

(57) ABSTRACT

An advertisement for leather clothing comprising at least one image, and including reference to a first state, reference to a second state, and indicating that transformation from said first state to said second state may be facilitated by wearing at least one leather garment.

### FIELD OF THE INVENTION

The invention relates to the fields of clothing sales and clothing advertising, and more particularly to the sale and advertising of leather clothing.

### BACKGROUND OF THE INVENTION

In the past, various methods of advertising have been used to promote the sale of leather clothing. Often, such advertising was based on market research into consumer attitudes. However, there was a need to produce more effective advertisements to better promote sales.

### SUMMARY OF THE INVENTION

In one embodiment, the invention comprises a business method to promote the sale of leather garments, comprising the steps of publishing an advertisement, the advertisement directed to selected potential customers, the advertisement comprising at least one image, the advertisement including reference to a first state, reference to a second state, and that transformation from said first state to said second state may be facilitated by wearing at least one leather garment.

In another embodiment, the invention comprises an advertisement for leather garments comprising a textual component conveying a first state and a graphic component conveying a second state, the advertisement indicating that transformation from said first state to said second state may be achieved by wearing at least one leather garment.

A further and better understanding of the present invention may be had by reference to the attached drawings.

### BRIEF DESCRIPTION OF THE DRAWINGS

FIG. 1 is a first embodiment of an advertisement according to the present invention.

FIG. 2 is a second embodiment of an advertisement according to the present invention.

### DETAILED DESCRIPTION OF THE PREFERRED EMBODIMENTS OF THE INVENTION

In my book entitled “7 Secrets of Marketing in a Multi-Cultural World”, published in 1991 by Executive Excellence Publishing (ISBN 1-890009-74-1; Library of Congress Card Number 99-75887), and which is incorporated by reference herein in its entirety, the concept of a “cultural archetype” is described. Each culture has a collective cultural unconscious—a pool of shared imprints that guides the behaviors of each member of that culture. A cultural archetype determines how members of a culture perceive their world and react to it. The “archetype discovery process” is used to determine a culture's archetypes and codes as they relate to a particular product. This process involves a plurality of “imprinting sessions” wherein participants are assisted to remember the imprintings of a product under study. An “imprinting session” consists of several components. In a first component, participants will describe their ideas and feelings about the product. In a second component, free association and storytelling exercises are used to uncover the unconscious dimensions or “latent structures” of the product. During a third component, participants are placed in a state of “wakeful relaxation” to assist them in remembering their imprinting experiences involving the product. These results are then analyzed.

It has been found that emotional experiences create “mental highways” that will be unconsciously re-used throughout a person's life, causing the person to re-experience the same type of emotion that was experienced during the original imprinting. The “logic of emotion” is the predictable set of feelings that result from the way persons experience events for the first time.

When experiencing emotion, three parts of the human brain are involved: (1) the reptilian brain, which deals with instinct, basic survival and reproduction; (2) the amygdalian brain, which is the emotional center; and (3) the cortex, which deals with language, vision and conscious thought. There is a reptilian “hot button” for every activity; when the “hot button” is activated, a person is prompted to something out of instinct. The reptilian brain is the source of most pressure to act, although how the pressure is dealt with will depend on the cortex.

Cultural archetypes, and in particular emotional archetypes, are primarily located in the amygdalian brain. These act as near-permanent emotional highways that determine how a person will perceive and interact with the world. These emotional highways exert a strong influence on conscious behavior, while the reptilian brain provides the body with the instinctive behaviors to fight, flee and engage in reproductive activity.

In accordance with this invention, this archetype discovery process is used to determine the archetype for leather clothing and then the results are used to develop advertising. After conducting a series of imprinting sessions, it has been determined that the emotional archetype for leather clothing centers on its transformative effect, and that an advertising campaign emphasizing this transformative effect would utilize the pre-existing emotional archetype for leather clothing, and thereby be more effective than other types of advertising. It has further been determined that making the transformation one of a sexual nature, namely from a person who is less sexual into a person who is more sexual, would trigger a reptilian reproductive response which would then be channeled through the emotional archetype for leather clothing to improve the likelihood of the advertisement having the desired effect. The result of this technique, therefore, was the determination that by emphasizing the transformative nature of leather clothing, it is possible to produce a useful, concrete and tangible result, namely, an effective advertisement for leather clothing. In particular it has been determined that such an advertisement can be made yet more effective when the transformations involved is from a person who is less sexual to a person who is more sexual.

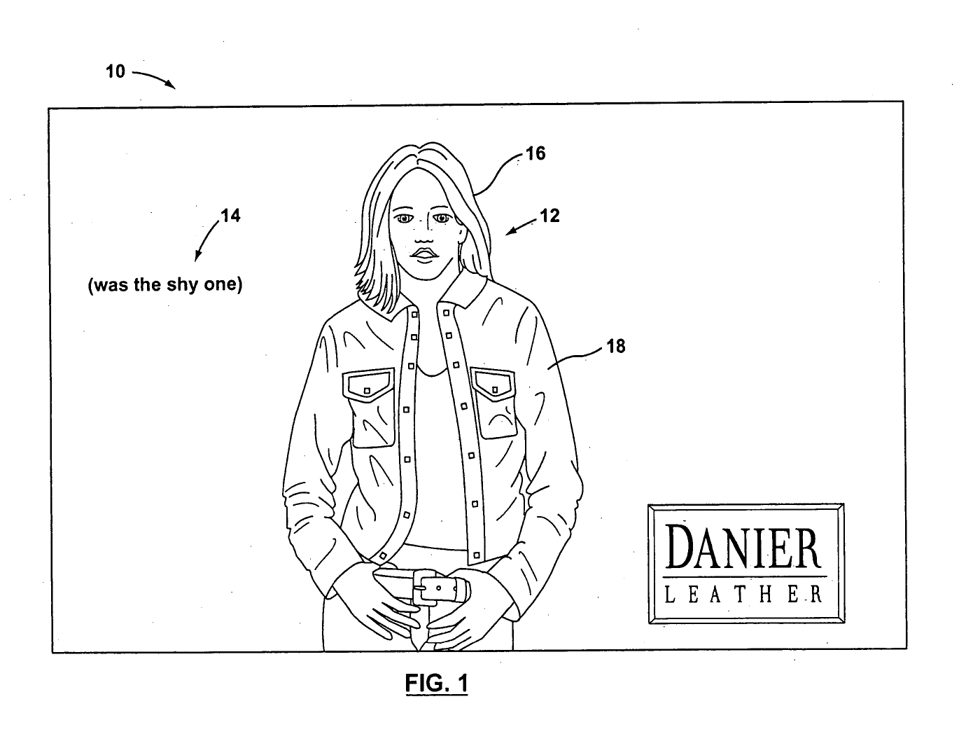

Referring now to FIG. 1, an advertisement in accordance with a first embodiment of the present invention is depicted generally at 10. The advertisement 10 includes two components, an image 12 and a textual component 14. The two components reference two states. The textual component 14 references the first state, and the image 12 references the second state. The first state is a state of low or non-existent sexuality, relative to the second state, as evidenced by the use of the colloquial term, “the shy one” in the textual component 14, indicating a person who was relatively less likely to engage in sexual activity or attract a romantic partner as compared to the person depicted in the second state. The second state is a state of high or enhanced sexuality, as evidenced by the attire, facial expression and body posture of the model 16 depicted in the image 12, all of which may collectively be described colloquially as “come hither” facial and body language. The use of the image 12 is indicative of the present and therefore references the second state, and the use of the word “was” in the textual component 14 indicates the past tense, and that the text, “the shy one” therefore references the first state. Between these two states a transformation has occurred. The prominent position of the leather jacket 18 on the model 16 indicates that the transformation from the first state to the second state was facilitated by wearing the leather jacket 18. The present invention is not limited to leather jackets but extends to any type of leather clothing.

It will be appreciated by one skilled in the art that any aspect of the reptilian brain may be used to select the two states. If the reproductive aspect is selected, the first and second states may pertain to sexuality as in the advertisement 10. Alternatively, and by way of example only, the survival component of the reptilian brain could be selected, and the first and second states may pertain to confidence and assertiveness, or could pertain to the capacity to intimidate or defeat at least one opponent in a physical confrontation. In each case however, there is a first state a second state and a transformation has occurred which is related to the leather garment 18 illustrated in the advertisement.

It will also be appreciated that the advertisements in accordance with the present invention can be integrated into a business involving the sale of leather garments by publishing the advertisement 10 in such a way that it is directed at selected potential customers. Such a business method may further include the steps of accepting orders for leather clothing from these potential customers; receiving payment from the potential customers; and delivering the leather clothing to the potential customers.

The selected customers for the advertisement 10 of the present invention may be males and/or females by varying the image 12 and/or textual component 14.

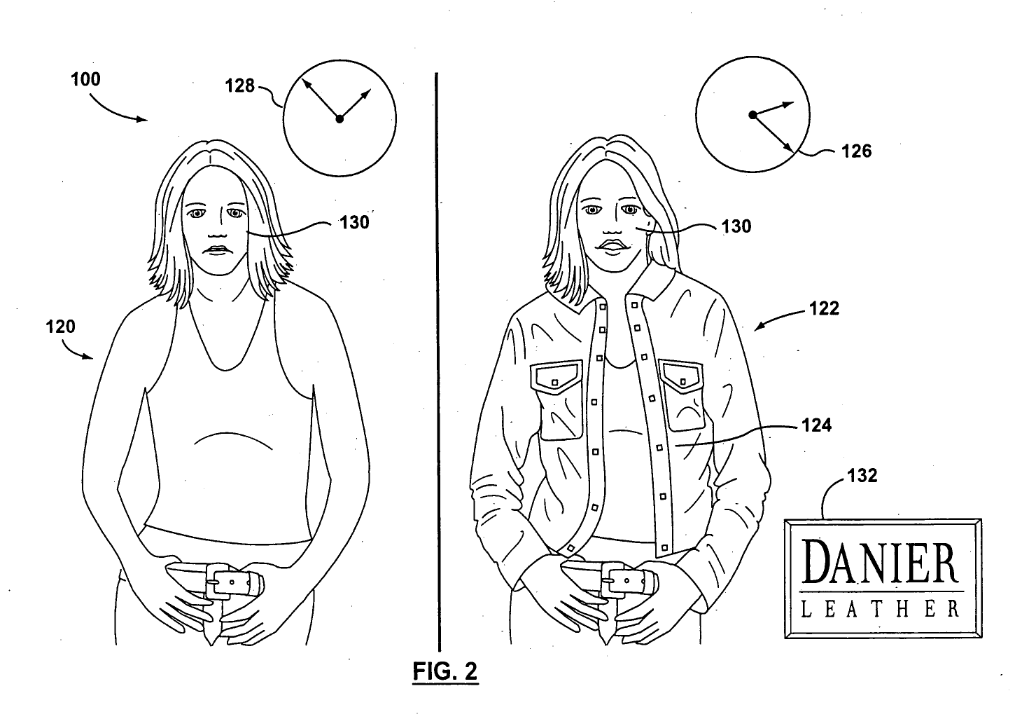

Referring now to FIG. 2, an advertisement 100 in accordance with the present invention is depicted. It is not necessary to have any textual component in the advertisement 100. The advertisement 100 contains two images 120 and 122 referencing the selected first and second states, respectively, and indicating that transformation from the first to the second state may be facilitated by wearing a leather garment 124.

The images 122 and 120 contain sufficient information to establish which is the first state and which is the second state. In this advertisement 100 clocks 126 and 128 serve this function. Image 122 depicts model 130 wearing leather garment 124, and model 130 is in a state of sexuality. The fact that image 122 is on the right side of the advertisement 100, and the fact that clock 126 depicts a time approximately half an hour later than that depicted by clock 128 in image 120, indicates that the state referenced by the image 122 is the second state. Image 120 depicts model 130 without a leather garment, and model 130 as depicted in image 120 is in a less sexual state than the state depicted in image 122. Similarly, the fact that image 120 is on the left side of the advertisement 100, and the fact that the clock 128 depicts a time approximately half an hour earlier than that depicted by clock 126 in image 122, indicates that the state referenced by image 120 is the first state. The presence of leather garment 124 in image 122 and its absence in image 120 indicates that leather garment 124 facilitated the transformation from the first state depicted by image 120 into the second state depicted by image 122. It will be noted that advertisement 100 contains no textual component except for trade name 132.

Clocks 126 and 128 could be replaced by words giving a time concept such as “THEN” and “NOW”, respectively, such that the combination of the word “THEN” and image 120 refers to the first state, and the combination of the word “NOW” and image 122 refers to the second state.

It will also be appreciated that the various adaptations described in relation to the advertisement 10 depicted in FIG. 1 are equally applicable to the advertisement 100 depicted in FIG. 2.

1. A method to promote the sale of leather garments, comprising the steps of publishing an advertisement, the advertisement directed to selected potential customers, the advertisement comprising at least one image, the advertisement including reference to a first state, reference to a second state, and that transformation from said first state to said second state may be facilitated by wearing at least one leather garment.

2. The method of claim 1, comprising the additional steps of accepting orders for leather clothing from said potential customers; receiving payment from said potential customers; and delivering said leather clothing to said potential customers.

3. The method of claim 1, wherein the first and second states are emotional states and the method includes the additional steps of selecting the first and second state according to brain functions of the reptilian portion of the human brain.

4. The method of claim 3, wherein the selected reptilian brain function is reproduction.

5. The method of claim 4, wherein the second state is sexuality.

6. The method of claim 3, wherein the selected reptilian brain function is survival.

7. The method of claim 6, wherein the second state is a state of confidence.

8. The method of claim 6, wherein the second state includes confidence in a physical confrontation.

9. The method of claim 1, wherein the potential customers are adult females.

10. The method of claim 1, wherein the potential customers are adult males.

11. An advertisement for leather garments, said advertisement comprising a textual component conveying a first state and a graphic component conveying a second state, said advertisement indicating that transformation from said first state to said second state may be achieved by wearing a leather garment.

12. The advertisement of claim 11, wherein the first, and second states are emotional states and the second state is sexuality.

13. The advertisement of claim 11, wherein said first state and second states are selected according to brain function of the reptilian portion of the human brain.

14. The advertisement of claim 13, wherein the selected function of the reptilian portion of the human brain is reproduction.

15. The advertisement of claim 14, wherein said second state is an enhanced image of sexual attractiveness.

16. The advertisement of claim 13, wherein said function of the reptilian portion of the human brain is survival.

17. The advertisement of claim 16, wherein the second state is a state of confidence and assertiveness.

18. The method of claim 6, wherein the second state includes the capacity to intimidate or defeat at least one opponent in a physical confrontation.
